(19) United States
(12) Patent Application Publication
(10) Pub. No.: US 2011/0155716 A1
(43) Pub. Date: Jun. 30, 2011

(54) STONE PANEL

(76) Inventor: George JACOB, Bangalore (IN)

(21) Appl. No.: 12/977,344

(22) Filed: Dec. 23, 2010

Related U.S. Application Data
(63) Continuation-in-part of application No. PCT/EP2009/057971, filed on Jun. 25, 2009.

(30) Foreign Application Priority Data
Jun. 25, 2008 (IN) 1540/CHE/2008
Sep. 1, 2008 (IN) 2140/CHE/2008
Sep. 22, 2008 (IN) PCT/IN2008/000601
May 14, 2009 (IN) 1122/CHE/2009

(51) Int. Cl. H05B 3/02; B23P 19/00

(52) U.S. Cl. 219/482; 29/426.2

(57) ABSTRACT

The present invention relates to a stone panel comprising a top layer, wherein the top layer comprises stone having a surface suitable for forming a floor surface or wall surface when the stone panel is in use; a middle layer comprising a heating assembly which is configured such that it is capable of heating the top layer, and a bottom layer configured to provide structural support to the tope and middle layers and wherein the bottom layer comprises thermally insulating material. The present invention also relates to a method of manufacturing these stone panels and to a control system operable to selectively power one or more of these stone panels.

### RELATED APPLICATIONS

This application is a Continuation-in-Part of PCT/EP2009/057971, filed on Jun. 25, 2009, published in English, which application is incorporated by reference in its entirety herein. This application claims the benefit of priority from Indian Patent Application number 1540/CHE/2008 filed on Jun. 25, 2008, Indian Patent Application number 2140/CHE/2008 filed on Sep. 1, 2008, International Patent Application number PCT/IN2008/000601 filed on Sep. 22, 2008, and Indian Patent Application number 1122/CHE/2009 filed on May 14, 2009, each application of which is incorporate by reference in its entirety herein.

### FIELD OF THE INVENTION

The present invention relates to a stone panel. In particular the present invention relates to a stone panel with a heating means. The present invention also relates to a method of manufacturing stone panels and to a control system operable to selectively power a stone panel.

### BACKGROUND TO THE INVENTION

Modern buildings, such as the typical family home, are often built from concrete, bricks or stone and are provided with concrete flooring. It is desirable to the residence of such buildings that the surface of the floors of these modern buildings be warm and that the walls are thermally insulating. Concrete has poor insulation properties, thus the concrete floors of modern buildings are difficult to heat and are very poor at retaining heat once heated. To ensure that the surfaces of the floors are warm it is common to cover these concrete floors with carpet material or wooden floor boards. As these carpet materials and wooden floor boards have good insulating properties they provide a warm floor surface.

In many cases it is desired to have a stone, ceramic or marble surface on a floor or wall of a building. To achieve this, the floor or wall is covered with stone, ceramic or marble slabs. However, similar to concrete, these materials also have poor insulation properties and so are difficult to heat and are very poor at retaining heat once heated. Thus, the user is required to compromise the heat of the floor surface (and the overall heat of the room) in order to have a stone, ceramic or marble flooring surface. Additionally, due to their poor insulation properties, covering the surfaces of the walls inside a building with the stone, ceramic or marble slabs will reduce the overall temperature inside the building.

The poor insulation properties of these stone slabs is a particular problem when there are used to form the flooring (or the wall surface) of buildings located in colder climates.

Additionally, the stone, marble or ceramic slabs are brittle in nature and can easily break if dropped, subjected to impact or machined. These slabs are particularly vulnerable to breakage in a “building site” environment. Careful handling is required by workers when the slabs are being laid. Additionally, due to their heavy weigh, handling of the slabs can be difficult.

It is an aim of the present invention to obviate or mitigate one or more of the aforementioned disadvantages.

### SUMMARY OF THE INVENTION

According to a first aspect of the present invention there is provided a stone panel comprising

a top layer, wherein the top layer comprises stone having a surface suitable for forming a floor surface or wall surface when the stone panel is in use;

a middle layer comprising a heating assembly which is configured such that it is capable of heating the top layer, and

a bottom layer configured to provide structural support to the top and middle layers and wherein the bottom layer comprises thermally insulating material.

Preferably, the bottom layer comprises insulation plastic, calcium silicate, wood, paper, plywood, metal (such as aluminium) or fibreglass. More preferably the bottom layer comprises a composite material of fibreglass, plastic and calcium silicate.

The bottom layer may comprise a first layer and a second layer and an intermediate layer interposed between the first and second layers. The first layer may comprise silicon sheets, fibre laminates, non-flammable rubber, plastic laminates or fibreglass. Preferably, the first layer comprises fibreglass. The second layer my comprise silicon sheets, fibre laminates, non-flammable rubber, plastic laminates or fibreglass. Preferably, the second layer comprises fibreglass.

The first layer, second layer and intermediate layer may be connected by means of an adhesive. The adhesive is preferably a thermally conductive adhesive. The adhesive may be polyurethane glue or epoxy glue.

The intermediate layer may be configured to define one or more air pockets between the first and second layers. Preferably, the intermediate layer is a webbed structure. Preferably, the intermediate layer is configured to define a plurality of hexagonal-shaped air pockets between the first and second layers. The base layer may comprise an aluminium honeycomb-shaped structure or a polypropylene honeycomb-shaped structure.

The bottom layer may have a thermal conductivity in the range of 0.1 W/mK-2 W/mK.

The bottom layer may have one or more apertures defined therein to facilitate electrical connection of the heating assembly to a power source.

The top layer may comprise any type of natural stone or artificial stone. For example, the top layer may comprise granite, marble, soapstone, limestone, sandstone, quartz, slate, mosaic, travertine or breccia.

The top layer may have a thickness of between 2 mm-20 mm. Preferably, the top layer has a thickness of between 2 mm-6 mm. The base layer may have a thickness of between 8 mm-15 mm.

The middle layer may comprise a foil. Preferably, the foil comprises a polyester film or plastic sheet.

The middle layer may be of any thickness. Preferably, the middle layer has a thickness of between 0.12 mm-2 mm.

The heating assembly may be integral to the stone panel. For example, the heating assembly may be integral to the middle layer of the stone panel.

The heating assembly may be a heating circuit which is printed on the foil of the middle layer. The heating assembly may comprise one or more heating elements. Preferably, a plurality of heating elements is provided. Preferably, the or each heating element is an electrical heating element. The or each electrical heating element may be configured to generate heat when conducting electricity. Preferably, the or each electrical heating element comprises one or more carbon resistors. More preferably, the one or more heating elements are formed by means of a carbon ink which is printed on a foil of the middle layer.

The or each heating element may be arranged in any configuration. The heating elements may be arranged as a series of parallel members. Alternatively, the heating elements may be arranged as a series of crossed members. Alternatively, the heating elements may be a series of meandering members.

The top layer, middle layer and bottom layer may be connected by any suitable connecting means. Preferably, the layers are connected by means of an industrial adhesive. Additionally, or alternatively, the layers may be connected by means of fasteners, for example screws. Preferably, the fasteners comprise insulating material.

A fixing means may be further provided. The fixing means will facilitate fixing the stone panel to a surface. The fixing means may comprise a base having an first surface and a second surface, wherein the first surface is suitable for co-operating with an adhesive to secure the fixing means to a surface and the second surface comprises one or more connectors co-operable with the one or more connectors of the stone panel to secure the stone panel to the fixing means. The one or more connectors on the second surface of the base of the fixing means may be male connector members.

The bottom layer of the stone panel may comprise one or more connectors which are co-operable with the one or more connectors of the fixing means to secure the stone panel to the fixing means. The one or more connectors provided on the bottom layer of the stone panel may be female connectors suitable for receiving one or more male connector members of the fixing means.

The base of the fixing means may be secured at its fist surface to a floor surface, or wall surface, independent of the stone panel, by means of cement (or some other form of adhesive) or fasteners such as screws. Once the base of the fixing means has been secured to the floor surface or wall surface, the stone panel may be subsequently positioned on the fixing means such that a male connector member on the second surface of the base of the fixing means is received into a female connector provided in the bottom layer of the stone panel. The stone panel is thus fixed to the floor surface or wall surface.

According to a second aspect of the present invention there is provided a control system suitable for selectively transmitting power from a power source to the heating assembly of one or more stone panels, the control system comprising, one or more input communication lines and a corresponding number of output communication lines; one or more programmable switches interposed between the or each input communication line and its corresponding output communication line, wherein the programmable switches are programmable to selectively provide an electrical connection between an input communication line and its corresponding output communication line based on a predetermined variable value, wherein the predetermined variable may be the temperature of a top layer of a stone panel and/or time and/or the amount of power generated the power source.

The control system may comprise a means for choosing to deliver power from one of a plurality of power sources, to the one or more stone panels, depending on amount of power generated by each power source. For example, the control system may be in communication with a plurality of renewable energy sources such as a wind generator, a wave generator, a solar generator and a non-renewable energy source such as a battery. The control system may choose to deliver power from either of the renewable energy sources, to the one or more stone panels, depending on which renewable energy source is generating the most power. When all of the renewable energy sources are generating power which is below a threshold power level, the control system can choose to deliver power to the one or more solar panels from the non-renewable energy source.

Preferably, the control system will comprise a plurality of input communication lines, a plurality of output communication lines, and a plurality of programmable switches.

The control system may further comprise an energy storage device suitable for storing energy generated by a power source.

The control system may comprise one or more timers. Preferably, the number of timers provided is equal to the number of stone panels. The timers may be configured to generate a switching signal at the end of predetermined period of time, wherein the switch signal causes the control system to switch to deliver power to the heating assembly of another stone panel.

The control system may comprise one or more temperature sensors. Preferably the number of temperature sensors provided is equal to the number of stone panels. The temperature sensors may be configured to generate a switching signal when a predetermined temperature is sensed, wherein the switching signal causes the control system to switch to deliver power to the heating assembly different stone panel. Preferably, a temperature sensor is located on a surface of each stone panel and is configured to measure the temperature of the surface of the stone panel and generate a switching signal when the temperature of the surface of the stone panel reaches a predetermined temperature. Additionally, or alternatively, the one or more temperature sensors may be configured to measure ambient temperature and to generate a switching signal when the ambient temperature reaches a predetermined value, wherein the switching signal causes the control system to switch to deliver power to the heating assembly of another stone panel.

According to a third aspect of the present invention there is provided a method of powering a heating assembly of a stone panel, the method comprising
(i) generating power in a power source;
(ii) transmitting the generated power via a plurality of input lines to a control system which comprises a plurality of programmable switches; (iii) implementing a switching sequence for the plurality of the programmable switches based on the temperature of a top layer of a stone panel and/or time, to periodically electrically connect selected input lines to a corresponding output line to cause electrical energy to be transmitted to a heating assembly of a stone panel to power the heating assembly.

According to a third aspect of the present invention there is provided a method of making stone panels comprising the steps of,
(i) providing a first bottom layer of insulating material configured such that it is capable of providing structural support to layers attached to it; (ii) securing a first middle layer, which comprises a first heating assembly, to the first bottom layer; (iii) securing a top layer comprising stone, at a first surface thereof, to the first middle layer; (iv) securing a second middle layer, which comprises a second heating assembly, to a second surface of the top layer;
(v) securing a second bottom layer of insulating material configured such that it is capable of providing structural support to layers attached to it, to the second middle layer;
(vi) cutting the top layer, along a central plane thereof, to half the top layer and provide two stone panels each stone panel comprising a bottom layer, a middle layer comprising a heating assembly and a top layer comprising stone.

### BRIEF DESCRIPTION OF THE DRAWINGS

An embodiment of the invention will now be described by way of example only, with reference to the accompanying drawings which are,

FIG. 1 which provides an exploded view of the stone panel according to the present invention;

FIG. 2a provides a cross-sectional view of a further embodiment of the of the present invention;

FIG. 2b provides a plan view of the stone panel of FIG. 2a, taken across line A-A′ of FIG. 2a;

FIG. 3 provides a plan view of a heating assembly used in the present invention;

FIG. 4 provides a plan view of further embodiment of the heating assembly used in the present invention;

FIG. 5 is a block diagram illustrating a control system controlling communication between a power source and stone panels according to the present invention;

FIG. 6 is a schematic of the control system used in the arrangement shown in FIG. 5;

FIG. 7 provides a side view of a fixing means which facilitates fixing the stone panel of the present invention to a surface.

### DETAILED DESCRIPTION OF THE DRAWINGS

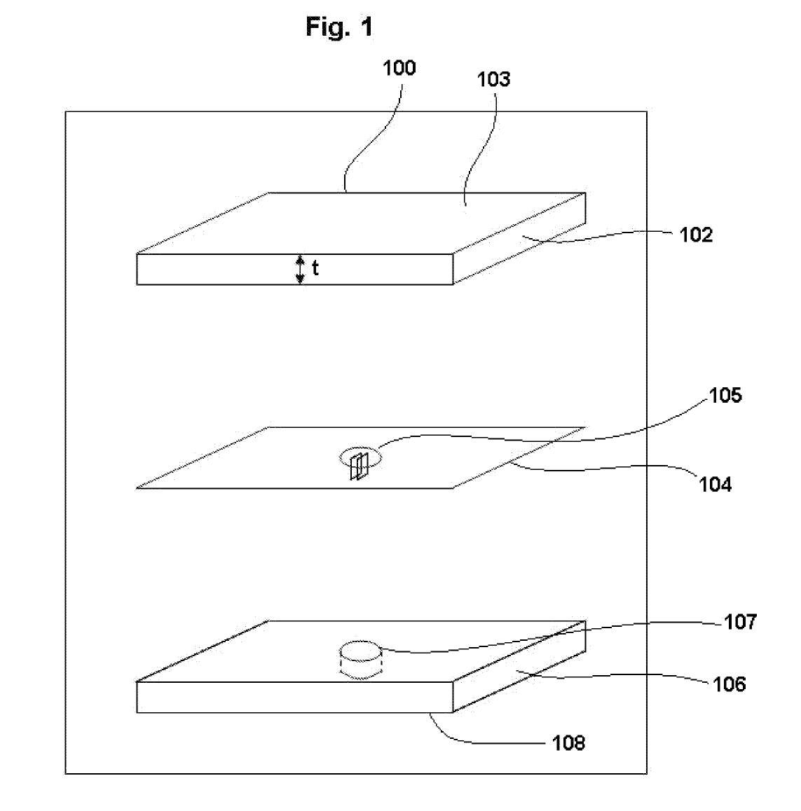

FIG. 1 provides an exploded view of a stone panel 1 according to the present invention.

The stone panel 100 comprises a top layer 102, a middle layer 104 and a bottom layer 106, in a stacked arrangement. The layers 102,104,106 are connected by means of an industrial adhesive (not shown).

The top layer 102 comprises stone and has a smooth upper surface 103 which is suitable for forming a floor surface when the stone panel 100 is in use. Optionally, the smooth upper surface 103 of the top layer 102 may have a decorative design. The top layer 102 has a thickness “t” of approximately 10 mm.

The middle layer 104 is sandwiched between the top layer 102 and the bottom layer 106. The middle layer 104 comprises a heating assembly (not shown) which is configured to heat the top layer 102. An electrical connection 105 is further provided in the middle layer to enable electrical connection of the heating assembly to an external power source.

The bottom layer 106 is a rigid layer of insulating material which is configured to provide structural support to the stone panel 100 and also to thermally insulate the middle layer 104. The bottom layer 106 has an under-surface 108 which is configured to co-operate with an adhesive, such as cement, to secure the stone panel 100 to a surface. The under-surface 108 of the bottom layer is a rough surface so as to facilitate cooperation of the under surface 108 with an adhesive. The bottom layer further comprises an aperture 107 defined therein. The aperture 107 houses the electrical connection 105 provided on the middle layer 104 when the middle layer is attached to the bottom layer 106. The aperture 107 will facilitate electrical connection of the heating assembly of the middle layer 104 to an external power source when the top, middle and bottom layers 102,104,106 have been connected together.

To apply the stone panel 100 to a surface, the surface is first covered with cement. While the cement is still wet the stone panel 100 is positioned so that the under-surface 108 of the bottom layer contacts the wet cement and the smooth upper surface 103 of the stone panel 100 remains exposed. As the cement dries the stone panel 100 is secured to the surface. A plurality of stone panels 100 may be laid to cover an entire floor surface, so that the exposed smooth upper surface 103 of the stone panels 100 forms a new floor surface. When a plurality of stone panels 100 are laid in series, grouting may be used to fill any gaps that exist between successive stone panels 100.

In use the heating assembly (not shown) of the middle layer 104 is activated. Heat generated by the heating assembly is conducted to the top layer 102 where it heats the smooth upper surface 103 of the top layer 102. In this manner the exposed surface of a laid stone panel 100 is heated. Heat generated by the heat assembly is prevented from being conducted away from the top layer 102 by means of the rigid insulating material which forms the bottom layer 106. Additionally, the rigid layer of insulating material which forms the bottom layer 106 will ensure that the stone panel 100 has improved robustness.

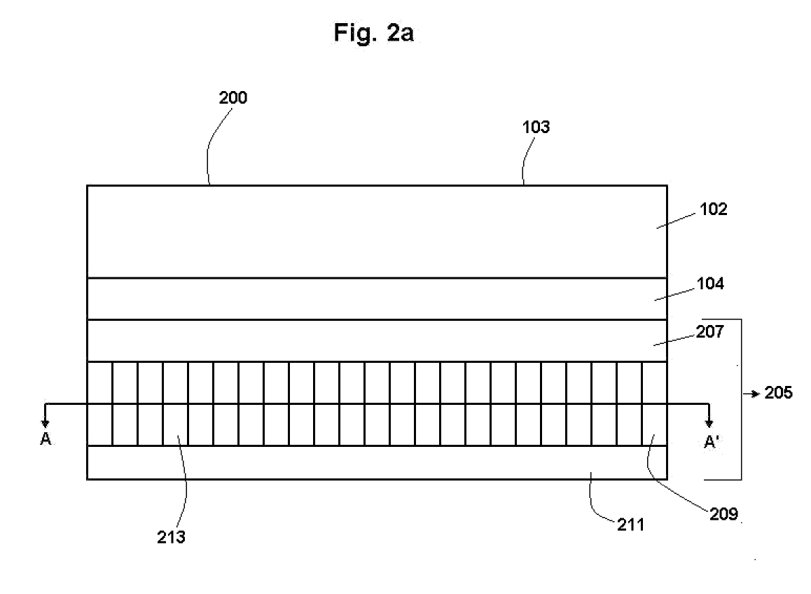

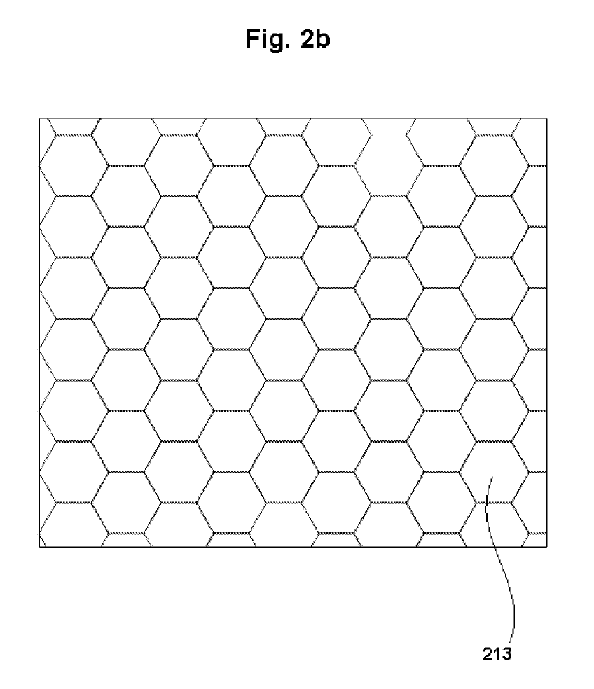

FIG. 2a provides a cross-sectional view of a further embodiment of present invention. FIG. 2a illustrates a stone panel 200. The stone panel 200 comprises many of the same features as the stone panel 100 of FIG. 1 and like features are awarded the same reference numerals.

The stone panel 200 comprises a base layer 205. The base layer 205 comprises a first layer 207 composed of fibreglass and a second layer 211 also composed of fibreglass. An intermediate layer 209 is interposed between the first 207 and second 211 fibreglass layers. The intermediate layer 209 is a webbed structure which defines a plurality of air pockets 213 between the first 207 and second 211 fibreglass layers.

FIG. 2b provides a plan view taken a long line A-A′ of FIG. 2a. The webbed structure which forms the intermediate layer 209 of the stone panel 200 is shown to define a plurality of hexagonally shaped air pockets 213 arranged in a honeycomb formation.

In use air trapped within the air pockets 213 of the intermediate layer 209 will provide insulation to the stone panel 200. Together with the first 207 and second 211 fibreglass layers, the intermediate layer 209 will prevent heat generated by the heating assembly in the middle layer 104 from travelling away from the top layer 102. Additionally, the intermediate layer 209 will provide improved structural support to the stone panel 200.

The stone panel 200, shown in FIG. 2a, is laid on a surface in a similar manner to the stone panel 100 shown in FIG. 1.

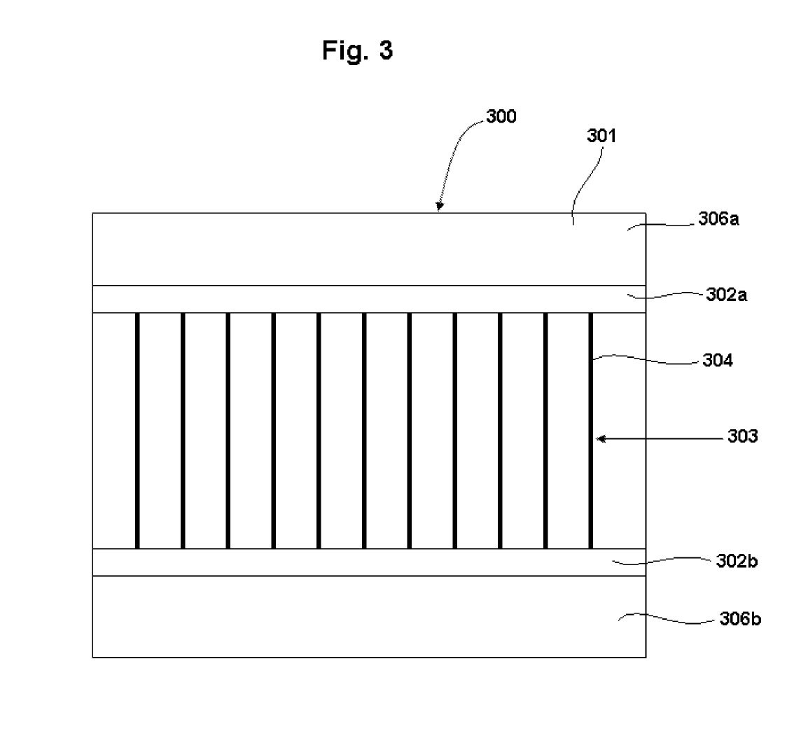

FIG. 3 provides a plan view of one embodiment of a heating assembly 300 of the middle layer 104 of the stone panels 100,200 shown in FIGS. 1 and 2a. The heating assembly 300 comprises a foil 301 having a first support member 306a and a second support member 306b. Fasteners, such as screws, may be arranged to penetrate the middle layer 104 in the region of the first 306a and second 306b support members so as to fasten the middle layer to a base layer 106.

An electrical heating circuit 303 is printed on the foil 301. The electrical heating circuit 303 comprises a first electrical contact member 302a which is provided proximate the first support member 306a and a second electrical contact member 302b which is provided proximate to the second support member 306b. The first electrical contact member 302a runs substantially the length of the first support member 306a and the second electrical contact member 302b runs substantially the length of the second support member 306b. The base layer 106 of the stone panel 100,200 will comprises an aperture which will facilitate electrical connection of the contact members 302a, 302b to a power source. The electrical heating circuit 303 further comprises a plurality of electrically conducting resistor rods 304 each of which run perpendicular to both the support members 306a, 306b and the contact members 302a, 302b. The electrically conducting resistor rods 304 electrically connect the first contact member 302a to the second contact member 302b. The first electrical contact member 302a, the second support member 306b, and each of the resistor rods 304 are formed by means of a conductive ink which is printed on the foil 301.

In use electrical current is applied to the first contact member 302a. Current will flow from the first contact member 302a through each of the resistor rods 304 and into the second contact member 302b. As current flows through the resistor rods 304, the rods 304 will heat. Heat generated in the resistor rods 304 is conducted to the top layer 102 of the stone panel 100,200.

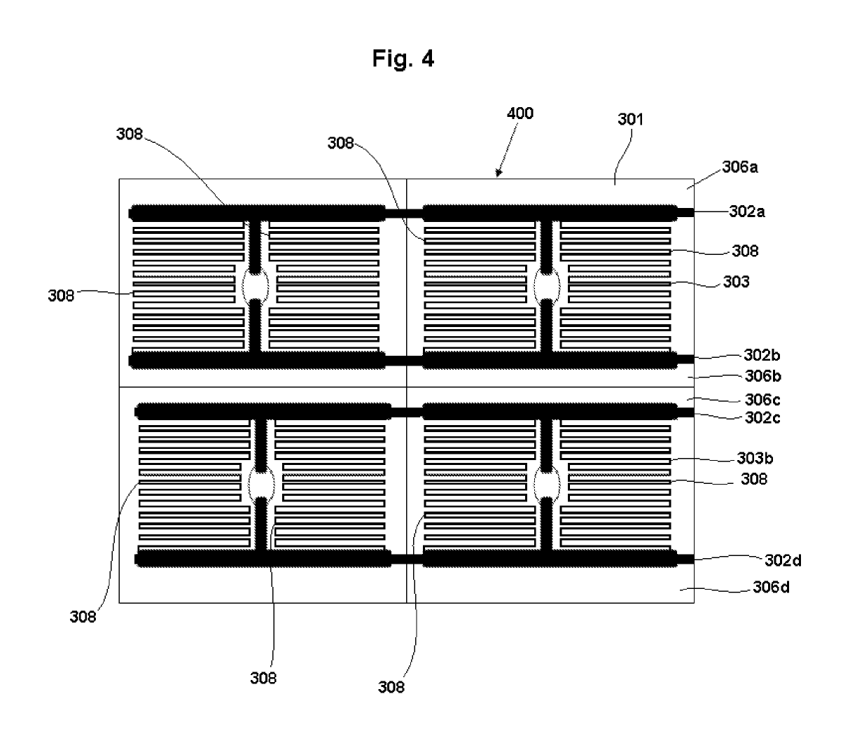

FIG. 4 provides a plan view of a further embodiment of heating assembly 400 which could form the middle layer 104 of the stone panels 100,200 shown in FIGS. 1 and 2a. The heating assembly 400 comprises many of the same features as the heating assembly 300 shown in FIG. 3 and like features are awarded the same reference numerals.

The heating assembly 400 comprises a third and fourth support members 306c, 306d. The heating assembly 400 comprises a second electrical heating circuit 303b printed on the foil 301. The second electrical heating circuit 303b comprises a third electrical contact member 302c located proximate to the third support member 306c and a fourth electrical contact member 302d located proximate to the fourth support member 306d. The third electrical contact member 302a runs substantially the length of the third support member 306c and the fourth electrical contact member 302d runs substantially the length of the fourth support member 306d. The base layer 106 of the stone panel 100,200 will comprises an aperture which will facilitate electrical connection of the contact members 302a, 302b, 302c, 302d to a power source.

A plurality of electrically conducting resistor rods 308 run in a meandering manner between the first 302a and second 302b contact members, and the third 302c and fourth 302d contact members, to electrically connect the respective contact members 302a, 302b, 302c, 302d. The contact member 302a, 302b, 302c, 302d, and each of the resistor rods 308 are formed by means of a conductive ink which is printed on the foil 301.

The heating assembly 400 operates in a similar manner to the heating assembly shown in FIG. 3.

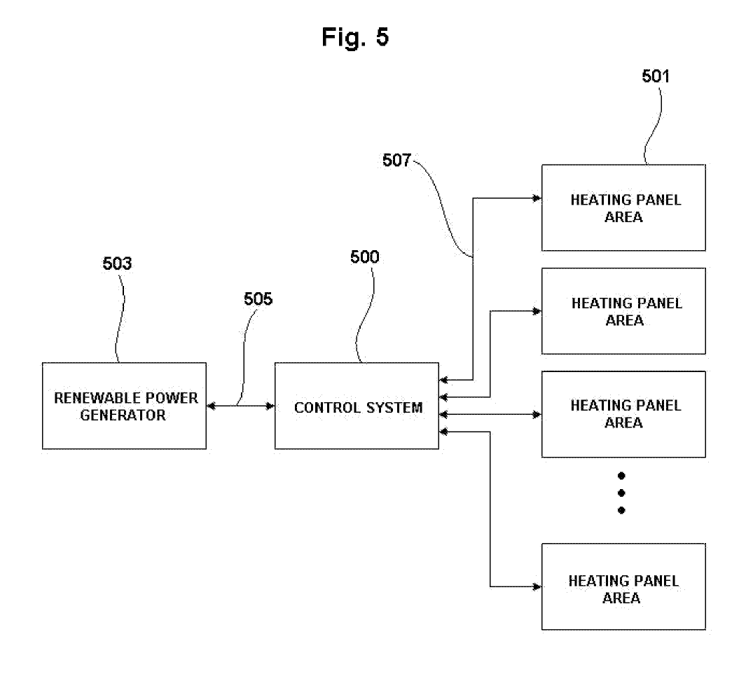

The supply of power to operate the heating assembly 300,400 of the middle layer 104 of the stone panel 100, 200, may be controlled by a control system. FIG. 5 provides a block diagram which illustrates how a control system could be used to control the supply of power to the heat assemblies of a series of stone panels.

The control system 500 shown in FIG. 5 is interposed between a renewable energy source 503 and a series of stone panels 501. Each of the stone panels 501 in the series comprises a heating assembly 300,400 (as shown in FIG. 3 or FIG. 4).

The renewable energy source 503 may take any form, for example the renewable energy source may be a wind generator, solar generator or a wave generator. Electrical energy generated by the renewable energy source is communicated to the control system 500 by means of input communication line 505. The control system 500 delivers power to the heating assembly of one or more of the series of stone panels 501 via output communication lines 507.

The control system 500 comprises a switching system which is configured to selectively deliver power from the renewable energy source 503 to the heating assembly of one or more of the series of stone panels 501. Programmable switches within the control system 500 operate to ensure that the control system 500 delivers power to the heating assembly of one or more of the series of stone panels 501 based on a threshold amount of time, temperature and power. For example, the programmable switches may be programmed to ensure that the control system 500 delivers power from the renewable energy source 503 to the heating assembly of a stone panel 501 for a period of “45 seconds” before switching to supply power to the heating assembly of the next stone panel 501 in the series. Alternatively or additionally, the programmable switches may be programmed to ensure that the control system 500 delivers power to the heating assembly of a stone panel 501 until its top layer 102 reaches a predetermined temperature (e.g. 260 C.) before switching to supply power to the heating assembly of the next stone panel 501 in the series.

Alternatively or additionally, the programmable switches may be programmed to switch depending on the amount of power generated by a renewable energy source 503. For example, the renewable energy source 503 may comprise a plurality of renewable energy generators such as a wind generator, wave generator, solar generator. The control system 500 may be in communication with each of the generators. The control panel 500 may be configured to determine which of the renewable energy sources is producing the most power and to deliver power from that renewable energy source to the heating assemblies of the stone panels 501. A non renewable energy source, such as a battery, may be further provided. The control system 500 may be in communication with the non renewable energy source. When the amount of power generated by each of the renewable energy sources is below a threshold power level the control system 500 will deliver power from the non-renewable energy source e.g. a battery, to the heating assemblies of the stone panels 501. It will be understood that the programmable switches may be programmed to switch on the basis of any other variable, for example ambient temperature.

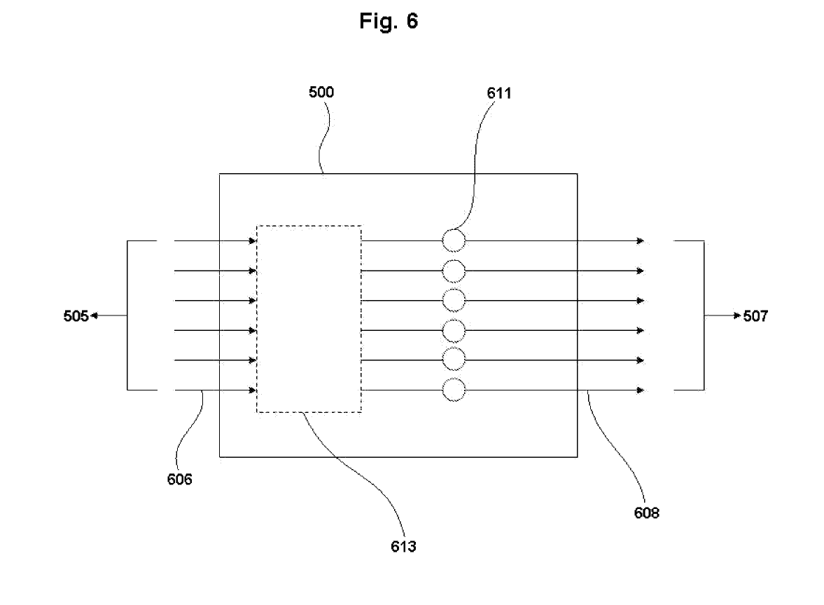

FIG. 6 is a schematic of the control system 500 used in the arrangement shown in FIG. 5. Input communication line 505 is shown to comprise a series of input sub-lines 606. Output communication line 507 is shown to comprise a series of output sub-lines 608. Each input sub-line 606 has a corresponding output sub-line 608. A programmable switch 611 is disposed between each input sub-line 606 and its corresponding output sub-line 608. The programmable switches 611 are programmed to sequentially and periodically electrically connect each successive input sub-line 606 to its corresponding output sub-line 608 depending on when power is to be delivered to the heating assembly 300,400 of a particular stone panel 501. The sequence and period which the programmable switch 611 connects an input sub-line 606 to its corresponding output sub-line 508 is dependant on variables such as time, temperature of the top layer 102 of a stone panel, and/or the amount of power being generated by the renewable power generator 503. The current values for each of these variables (i.e. time, temperature of the top layer 102 of a stone panel, and/or the amount of power being generated by the renewable power generator 503) is supplied to the control system 600 through input module 613. The input module 613 uses the current values of the variables to implement an appropriate switching sequence and switching time for each of the programmable switches 611.

The control system 500 further comprises an energy storage device (not shown). The energy storage device will store energy which has been generated by the renewable power source so that it can be later used to power the heat assemblies of the stone panels 501.

Advantageously, the control system 500 will reduce the power demand placed on the power supply.

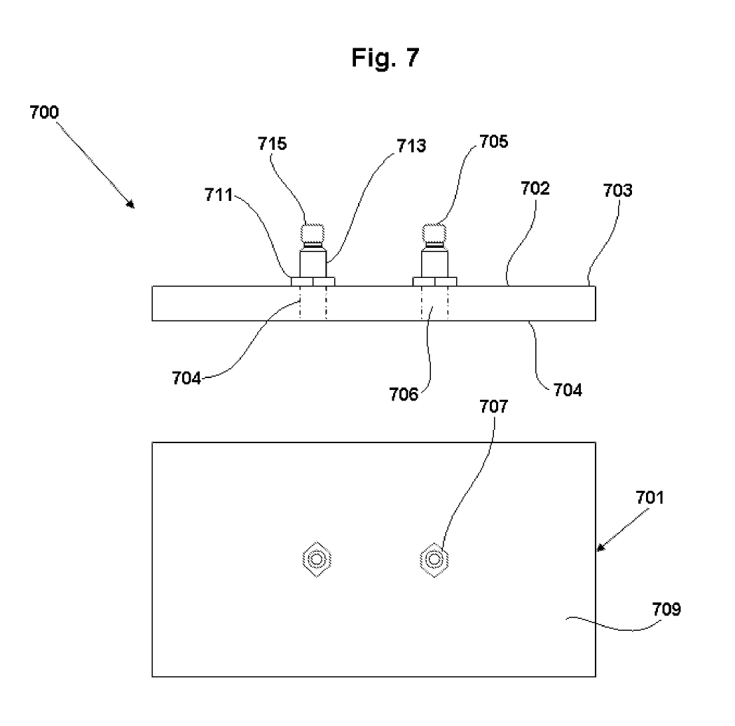

FIG. 7 provides a side view of a fixing means 700 which facilitates fixing a stone panel 701 to a surface. The fixing means 700 comprises a base 703 having a first surface 702 and a second surface 704. The base has two threaded recesses 704 defined therein.

Two male connector members 705 project from the first surface 702 of the base 703. Each of the male connector members 705 comprises a hexagonal base member 711. A shaft member 713 projects from one side the hexagonal base member 711. The shaft member 713 comprises a substantially spherical head member 715. A threaded member 706 extends from the opposite side of the hexagonal base member 711. Each male connector member 705 is secured to the base 703 by screwing the threaded member 706 of each male connector member 705 into the threaded recesses 704 provided in the base 703.

The stone panel 701 comprises a top layer (not shown) a middle layer (not shown) and a bottom layer 709. The bottom layer 709 of the stone panel 701 has two female connectors 707 defined therein configured to receive the male connector members 705 of the fixing means 700.

In use the base 703 of the fixing means 700 is secured, at its second surface 704, to the floor or wall surface independently of the stone panel 701. The base 703 is usually secured to the floor or wall surface by means of cement or some other form of adhesive or by means of a fastener such as a screw. Once the base 703 has been secured to the floor or wall surface the stone panel 701 may be subsequently positioned on the base 703 such that the male connector members 705 are received into a female connectors 707 defined in the bottom layer 709 of the stone panel 701, to fix the stone panel 701 to the floor or wall surface.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

What is claimed:

1. A stone panel heating system comprising
i. one or more stone panels, at least one stone panel comprising:
i. a top layer, wherein the top layer comprises a stone having a surface suitable for forming a floor or wall surface when the stone panel is in use;
ii. a middle layer comprising a heating assembly which is configured such that it is capable of heating the top layer, and
iii. a bottom layer configured to provide structural support to the top and middle layers;
ii. one or more connectors attached to the above stone panel for providing power to the heating assembly;
iii. one or more fixing means to secure the stone panel to a surface, said fixing means comprising one or more connectors co-operable with one or more connectors of above stone panel; and
iv. one or more power sources for heating the heating assembly of the stone panel, is optionally controlled by a power control system.

2. The stone panel heating system according to claim 1, wherein the bottom layer comprises thermally insulating material or conductive material or combination thereof.

3. The stone panel heating system according to claim 1 wherein the bottom layer comprises a first layer and a second layer and an intermediate layer interposed between the first and second layers.

4. The stone panel heating system according to claim 3, wherein the first layer and/or second layer comprise fibreglass.

5. The stone panel heating system according to claim 3, wherein the intermediate layer is configured to define one or more air pockets between the first and second layers.

6. The stone panel heating system according to claim 5, wherein the air pockets are hexagonal-shaped.

7. The stone panel heating system according claim 1 wherein the bottom layer has one or more apertures defined therein to facilitate electrical connection of the heating assembly to a power source.

8. The stone panel heating system according claim 1, wherein the middle layer of the heating assembly comprises a foil or one or more heating element.

9. The stone panel heating system according to claim 1, wherein the heating assembly comprises one or more heating circuit printed on the foil.

10. The stone panel heating system according claim 9, wherein the heating circuit comprises an electrically conductive ink.

11. The stone panel heating system according to claim 1, wherein the fixing means further comprising a base having an first surface and a second surface, wherein the first surface is suitable for co-operating with an adhesive to secure the base to a surface and the second surface comprises one or more connectors co-operable with one or more connectors of the stone panel to secure the stone panel to the base.

12. The stone panel heating system according to claim 1, wherein the control system is suitable for selectively transmitting power from a power source to the heating assembly of one or more stone panels, the control system comprising, one or more input communication lines and a corresponding number of output communication lines; and
one or more programmable switches interposed between the or each input communication line and its corresponding output communication line, wherein the one or more programmable switches are programmable to selectively provide an electrical connection between an input communication line and its corresponding output communication line based on a predetermined variable value.

13. The stone panel heating system according to claim 1, wherein powering the heating assembly of the stone panel comprising
i. generating and/or regulating a power source;
ii. transmitting the generated power via a plurality of input lines to a control system which comprises a plurality of programmable switches; and
iii. implementing a switching sequence for the plurality of the programmable switches based on the temperature of the top layer of the stone panel and/or time and/or the amount of power generated by the power source, to periodically electrically connect selected input lines to a corresponding output line to cause electrical energy to be transmitted to a heating assembly of the stone panel to power the heating assembly.

14. A method of making stone panel comprising the steps of,
i. providing a first bottom layer of insulating material or conductive material or combination thereof configured such that it is capable of providing structural support to layers attached to it;
ii. securing a first middle layer, which comprises a first heating assembly, to the first bottom layer;
iii. securing a top layer comprising stone, at a first surface thereof, to the first middle layer;
iv. securing a second middle layer, which comprises a second heating assembly, to a second surface of the top layer;
v. securing a second bottom layer of insulating material configured such that it is capable of providing structural support to layers attached to it, to the second middle layer; and
vi. cutting the top layer, along a central plane thereof to provide two stone panels each stone panel comprising a bottom layer, a middle layer comprising a heating assembly and a top layer comprising stone.

15. The stone panel system according to claim 1, wherein the heating assembly comprising a foil or one or more heating elements, a first support member, a second support member, one or more heating circuit and one or more means for attaching the heating assembly to the bottom layer.

16. The stone panel heating system according to claim 9, wherein the heating circuit comprises at least one first electrical contact member and at least one second electrical member, a plurality of electrically conducting resistor rods connecting perpendicularly the first electrical contact member and second electrically contacting member, and the first electrical contact member, the second electrical contact member and each of the electrically conducting resistor rods are formed by means of a conductive ink printed on the foil or by a resistive heating element

17. The stone panel heating system as claimed in claim 1, wherein the top layer stone is a natural stone.

18. The stone panel heating system as claimed in claim 12, wherein the predetermined variable may be the temperature of a top layer of the stone panel and/or ambient temperature and/or time and/or the amount of power generated by renewal power source.
